(19) United States
(12) Patent Application Publication
(10) Pub. No.: US 2006/0004535 A1
(43) Pub. Date: Jan. 5, 2006

(54) Creation and storage of simulated application-instrument communications

(76) Inventor: David K. Gladfelter, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/881,653

(22) Filed: Jun. 30, 2004

(51) Int. Cl. G01M 19/00

(52) U.S. Cl. 702/122

(57) ABSTRACT

A method for recording and modifying communications. In representative embodiments, communications on a communication link are detected. Those communications that occur between an application module and an instrument are selected from the detected communications. The instrument behavior associated with at least one of the selected communications differs from a predefined instrument behavior for that selected communication. The selected communications are stored in a storage module. At least one of the selected communications whose associated instrument behavior differs from the predefined instrument behavior is edited such that the resultant instrument behavior associated with the edited communication emulates the predefined instrument behavior.

### BACKGROUND

Initially, electronic instruments were stand-alone units designed for rather limited and specific applications. Modern measurement systems, however, often involve the control and querying of an instrument by applications operating on a computer or computers which may be located remotely from the instrument. As a result, communications now flow back and forth between computer based applications and their associated instruments over various types of communication links or networks.

Physically such communication links could be, for example, cables, infrared links, wireless links, etc. In order to reduce development costs, various standard electrical and mechanical interfaces were developed for instruments and other electronic devices. One such standard interface system is the Hewlett-Packard Interface Bus (HPIB) interface system, also known as the General-Purpose Interface Bus (GPIB) and by its Institute of Electrical and Electronic Engineers (IEEE) specification number, IEEE 488. HPIB is a scheme by which groups of devices may be connected to a controlling computer and communicate under its direction. Instruments from multiple vendors can be operated on the same HPIB system. However, instruments can use other standard interfaces such as serial/RS-232, VXI backplane, USB, or the like.

Also, with the advent of computer communication with and computer control of instruments and systems of instruments, standardized signal protocols were developed. These protocols were mainly intended to set standards for digital messages sent over, for example, the above interfaces. The Standard Commands for Programmable Instrumentation (SCPI) protocol standard was one such protocol developed to define a set of commands for controlling programmable test and measurement devices in instrumentation systems.

Applications address commands, which may be, for example, a command to apply a signal, make a measurement, perform a calibration, or the like, to one or more instruments over the communication link. The instruments may also send response messages back to the applications. The response messages may be measurement results, instrument settings, error messages, or the like. Prior to the SCPI standard, the commands that controlled a particular device function varied between instruments which had similar capabilities. SCPI provided a uniform and consistent language for the control of test and measurement instruments. The same commands and responses can control corresponding instrument functions in SCPI equipment, regardless of the supplier or the type of instrument. However, other protocols, as for example .NET, are becoming more and more popular in developing applications for instruments and instrument systems in the test and measurement field. .NET is an open software standard initially developed by Microsoft.

Instrument I/O (Input/Output) and Direct I/O are names often given to the software that is used to direct communications that occur over the communication link between the computer and the Instrument. Such I/O software is designed to call the correct operating system functions in order to send data to the device from the computer. When an application begins communication with an instrument, it opens an Input/Output session (an I/O session) by passing an address to the instrument. This act creates a virtual pipe between the application and the instrument which isolates their I/O from the other I/O on the communication link or network.

Agilent Technologies' I/O Monitor Application, which is part of the “Agilent T&M Programmers Toolkit” product, has the ability to listen to all communications taking place between any application and any instrument on the communication link that the I/O Monitor Application is listening to store and to recover those communications when requested. When so instructed, the trace application listens to all input/output communications on the communication link and, based on user inputs, selects which input/output communications to record. The user makes this choice based on a selection of an I/O session or sessions. Once chosen, the I/O Monitor Application records all data sent during the selected I/O session(s).

### SUMMARY

In representative embodiments, methods for recording and modifying communications are disclosed. Communications on a communication link are detected. Those communications that occur between an application module and an instrument are selected from the detected communications. The instrument behavior associated with at least one of the selected communications differs from a predefined instrument behavior for that selected communication. The selected communications are stored in a storage module. At least one of the selected communications whose associated instrument behavior differs from the predefined instrument behavior is edited such that the resultant instrument behavior associated with the edited communication emulates the predefined instrument behavior.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand those embodiments and their inherent advantages. In these drawings, like reference numerals identify corresponding elements.

FIG. 1 is a drawing of a record/playback simulation system as described in various representative embodiments consistent with the teachings of the invention.

FIG. 2A is drawing indicating various data structures of the storage module of FIG. 1.

FIG. 2B is a drawing indicating alternative data structures of the storage module of FIG. 1.

FIG. 3 is a flow chart of a method for transferring communications between an application module and an instrument and recording the communications.

FIG. 4 is a flow chart of a method for recording and editing communications transferred between the application module and the instrument.

FIG. 5A is a flow chart of a method for manually composing and storing communications.

FIG. 5B is a flow chart of a method for creating and storing an initial values data structure.

FIG. 5C is a flow chart of a method for creating and storing an associated values data structure.

FIG. 5D is a flow chart of a method for capturing and storing observable physical results.

FIG. 5E is a flow chart of a method for capturing and storing measurable results.

FIG. 6A is a flow chart of a method for simulating communications transferred between the application module and the instrument.

FIG. 6B is a flow chart of another method for simulating communications transferred between the application module and the instrument.

FIG. 7 is a drawing of an apparatus for capturing and storing observable physical results.

### DETAILED DESCRIPTION

As shown in the drawings for purposes of illustration, the present patent document discloses novel techniques for simulating the operation of an instrument under the control of an application by recording communications between an application and an instrument, by the editing of those recorded communications, and by the subsequent playback of the recorded/edited communications. Using these techniques, a user can simulate interactions between an application and an instrument such that it would appear to the application as if the instrument were actually present when in fact stimulus communications from the application are used to select and return to the application appropriate, prerecorded instrument response messages.

By recording communications (i.e., I/O communications) between an application and an instrument and by editing the recorded communications as appropriate, it is possible to customize test cases of software code that communicate with an instrument, reliably repeat tests of I/O related software code, and more easily observe the behavior of the code under test without causing instrumentation side-effects. The recorded I/O can be edited to test corner cases and to achieve better test coverage. Because the stored code can be deterministic if desired, the tests will have the same behavior from test-run to test-run, unlike most tests using real instruments. Because the playback system can be paused indefinitely during debugging without changing its behavior, test code can be more easily observed and monitored than in “live” instrument environments where the behavior of the external devices is often predicated on time.

Organizations have found that the number of instruments necessary for the desired parallel instrument-related engineering activities varies greatly depending on the current position in the development or product cycle of an instrument or application. Being able to virtually expand the number of available instruments by pre-recording instrument behavior can significantly increase the possible parallel development work, increase organizational efficiency, and decrease the product cycle time without purchase of additional instruments.

Instrument simulation permits more flexible use of software controlled instruments. It is sometimes difficult to transport instruments, especially instrument systems. By providing a method of using such software without the instruments themselves, it is easier to, for example, demonstrate such software in foreign countries, use the software on instruments that are still under development, and create scenarios and behaviors not possible with real instruments.

Using implementations of the representative embodiments disclosed herein, an instrument developer can record exactly what an instrument did, including its delays before returning from each command. The user can use editing features to modify that data in any way appropriate. Static data can be replaced with functions which could be, for example, written as Visual Basic scripts, which specify various instrument behaviors, and which keep track of the simulated instrument's state via an array or other mechanism associated with the instrument and the initiating application.

Thus, a few of the problems solved with simulation are improved testing of I/O-related software code, “virtual” sharing of limited instrument resources, and more flexible use of I/O-related software code.

In the following detailed description and in the several figures of the drawings, like elements are identified with like reference numerals.

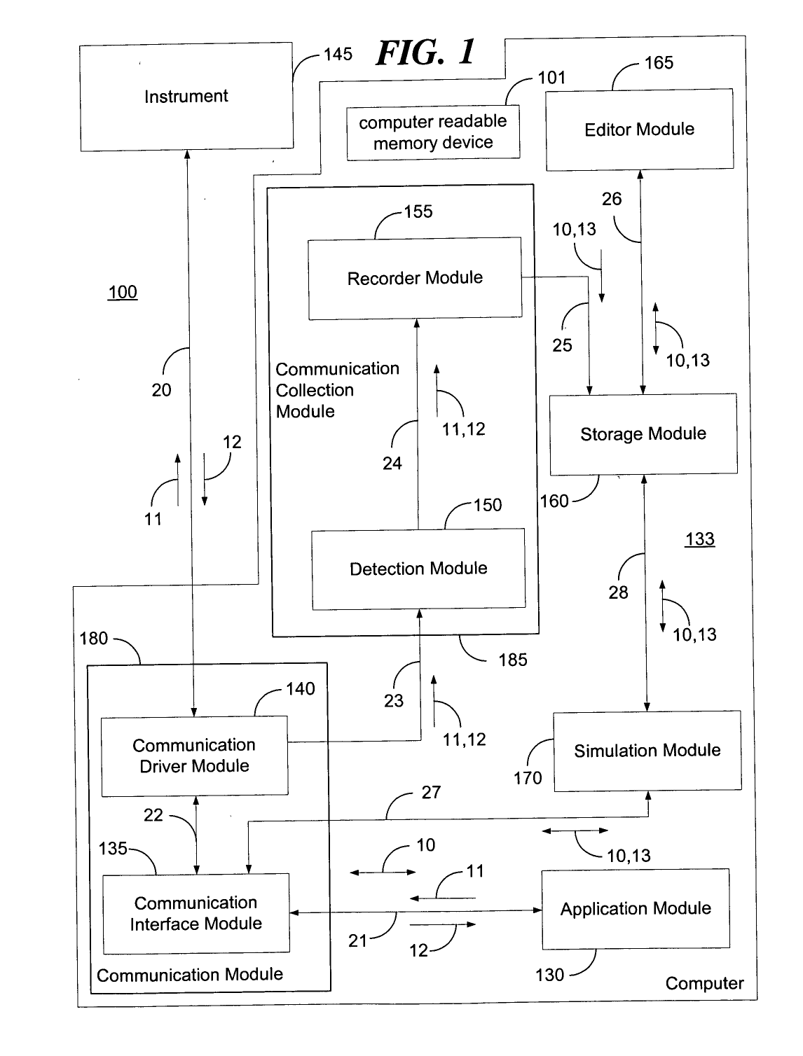

FIG. 1 is a drawing of a record/playback simulation system 100 as described in various representative embodiments consistent with the teachings of the invention. In FIG. 1, an application 130, also referred to herein as an application module 130, which, for example, could be located on a computer 133 sends communications 10 (indicated in FIG. 1 as commands 11) to an instrument 145 via a communication module 180. Communications 10 sent by the application 130 to the instrument 145 generally provide a stimulus to the instrument 145 in the form of commands 11 which either instruct the instrument 145 to perform a certain action or respond to queries for information. Representative commands 11 could, for example, instruct the instrument 145 to measure a current or to perform a self-calibration for a specified voltage range. In response to such a command 11, the instrument could, for example, return a response 12, also referred to herein as a message 12 and as a response message 12, which included the value of the current measured or an indication that the calibration procedure had been successfully completed respectively. In the representative embodiment of FIG. 1, all components except for the instrument 145 and the appropriate portion of the communication link 20 are located on the computer 133.

The commands 11, as transferred via first communication path 21 from the application module 130 to the communication interface module 135 of the communication module 180, are higher level program calls or routines referred to as Application Program(ming) Interface (API) functions and are used to control various applications on the instrument 145. The API's could be, for example the Agilent Technologies VISA-COM Application Programming Interfaces, and the application module 130 could communicate with external devices (i.e., the instrument 145) using Agilent Technology's I/O Libraries' VISA (Virtual Instrument System Architecture).

In the communication module 180, the commands 11 are first validated by a communication interface module 135 as to the correctness of form. The communication interface module 135 then converts the higher level API calls to appropriate lower level driver I/O API functions which will be used to communicate with the I/O type used for communication link 20. The I/O type could be, for example, TCPIP or GPIB, and the drivers could be, for example, TULIP drivers as found in the Aglient Technologies I/O Libraries. The validated, converted commands 11 are then transferred to a communication driver module 140, also referred to herein as a driver module 140, via second communication path 22.

The communication driver module 140 appropriately formats the commands 11 for transfer to the instrument 145 via communication link 20 using the correct I/O type which could be, for example, TCPIP or GPIB and transfers the commands 11 to the instrument 145. The instrument receives the commands 11 transmitted by the communication driver module 140 over the communication link 20.

If appropriate, the instrument 145 responds to the commands 11 with appropriate responses 12 which it transmits via communication link 20 to the communication driver module 140 in the communication module 180. The communication driver module 140 appropriately formats the responses 12 to the lower level driver I/O API's, which again could be the TULIP driver API's prior to transfer to the communication interface module 135 via the second communication path 22.

The communication interface module 135 validates the responses 12 as to the correctness of form, protocol, and parameters of the responses 12. The validated responses 12 are then transferred to the application 130 via the first communication path 21.

The sub-system just described comprising the application 130, the communication module 180 which in turn comprises the communication interface module 135 and the communication driver module 140, the instrument 145, the first and second communication paths 21,22, and the communication link 20 comprise an operational application controlled instrument 145 system, and the flow of communications 10 (commands 11 and responses 12) just described also represent the flow of communications in an operational application controlled instrument 145 system, also referred to herein as an operational application/instrument system functioning in an operational mode.

Another mode, the detection/record mode, can operate in conjunction with the operational mode. In the detection/record mode, a communication collection module 185 is connected to the communication module 180 via third communication path 23 and monitors or listens to the various communications 10 passing back and forth between the application module 130 and the instrument 145. In representative embodiments, there can be multiple application modules 130 communicating with multiple instruments 145 in multiple I/O sessions. A detection module 150, also referred to herein as an event server module 150, detects the communications 10 specified by the user and transfers those communications 10 to a recorder module 155 via fourth communication path 24. Such communications 10 could be detected by the detection module 150 at various points in the flow of communications 10. In a representative embodiment, it could be the driver level API's that are detected and subsequently stored by the recorder module 155. The detection module 150 could capture communications 10 from all I/O sessions active on the communication driver module 140 with selection for storage occurring after the capture process is terminated or the detection module 150 could selectively capture only communications 10 related to specified I/O sessions.

The recorder module 155 stores the appropriate captured communications 10 (commands 11 and responses 12) passing back and forth through the communication module 180 in a storage module 160, also referred to herein as an I/O record file 160 and as a simulation file 160, via a fifth communication path 25. The storage module 160 could use any number of different data storage types to store the communications 10, as for example, a file 160, a database 160, an array 160, a list 160, a linked list 160, a tree 160, an N-ary tree 160, and the like.

As a representative example, a user turns on the I/O detection and recording feature of the communication collection module 185 by activating the module (i.e., the application). Such actions might involve opening a window on the computer 133 monitor for the recording session and activating a recording button in that window. Depending upon user selection, there can be as many instances of the communication collection module 185 open and in the detection/record mode as there are instruments that the user wants to record communications 10 between.

For each recording communication collection module 185, the communication collection module 185 listens to the communications 10 passing through the communication driver module 140 attached to its associated communication link 20. In various implementations, the communication collection module 185 could listen to and capture the communications 10 in one or more various protocols from the API calls or alternatively listen and capture all of them associating each communication 10 with one of the current I/O sessions that it is listening to.

Once the communications 10 are completed, the user can select the I/O session that he/she wishes to turn into a simulation file. In a particular implementation, it may be desired to simulate a VISA session. There are typically 2-3 TULIP I/O sessions associated with one VISA session.

Once the user selects the appropriate I/O session, the recorder module 155 parses the communications 10 that it captured into a simulation data structure 13, which could be in the form of a tree 13, that is ready for editing or saving to disk. The recorder module 155 iterates through each event in each stream. Note that the I/O stream comprises events noting the beginning (“enter”) and end (“exit”) of commands 11 which could be, for example, TULIP “Read”, “Write”, and “DoCommand” commands 11. These events are turned into simulation data.

The recorder module 155 treats each Write “enter” stream event and DoCommand “enter” stream event as a stimulus, and for each stimulus that occurs it will search to see if it can find an identical stimulus has occurred in the past. If such a stimulus has not occurred previously, the recorder module 155 adds that stimulus to the list of stimuli and mark that stimulus as the current stimulus of that type (Write stimulus or DoCommand Stimulus). Otherwise, the recorder module 155 marks the matching existing stimulus as the current stimulus of that type.

If a response (either a Read command “exit” stream event or a DoCommand “exit” stream event) occurs, the current stimulus of that type (Write for a Read event or DoCommand “enter” for a DoCommand “exit” event) will have the output values of the response event stored as a new response for that stimulus event and added to the list of responses for that stimulus.

After completion of iteration through the stream data, a list of unique stimuli, each with its list of any associated responses will exist. These stimuli and responses are the simulation data that can be saved to an extensible markup language (XML) file that then is used by the simulation module 170 to simulate the I/O session. Other formats for storing the stimulation data could be another text markup language file format other than XML, a structured storage file format, a custom relational file format, a custom framed binary format, and the like. If the program that was run to create the data is run again with the same setup (except to use the simulated I/O rather than live I/O in the operational mode), it will typically receive the same responses from the simulated instrument as it received from the actual instrument 145. If the commands 11 are run out of order or if new commands 11 are run, the behavior of the simulated I/O session may be acceptable, but they would not typically be exactly the same as those that would occur when using the actual instrument 145.

In yet another mode, an edit mode, which can be activated separately from other modes, the editor module 165 that communicates with the storage module 160 via a sixth communication path 26 can retrieve communications 10 stored in the storage module 160, modify the retrieved communications 10, and return then to the storage module 160. In other representative embodiments, the editor module 165 can be used to manually create communications 10 and store them in the storage module 160. The editor module 165 can also be used to delete communications 10 from the storage module 160.

In a representative embodiment, the communication collection module 185 operates using a stimulus/response model. This model assumes that if a command 11 is sent, whatever response 12 is transmitted by the instrument 145 immediately before any other command 11 is sent is a result of having sent that command 11. The detection/record mode will captures the majority of the application/instrument interactions. Thus, a very good simulation will be obtained if exactly the same set of commands 11 are sent to the simulation module 170 as was sent in the operational mode.

However, in some cases a better simulation of the application/instrument interactions can be obtained if some editing of the entries in the storage module 160 is performed prior to running a simulation mode. This editing can add active elements that modify the simulated instrument responses. The communications 10 stored in the storage module 160 can be, for example, stored as an XML file which is a format that is easily read, parsed, and modified. The communications 10 can be written, for example, in SCPI, .NET, or other appropriate command language. It is also possible to use other storage formats and other command languages.

As the recorder module 155 prepares to store communications 10 into the storage module 160, it automatically builds up trees 13 of commands 11 and related responses 12 (i.e., the simulated data structure 13). These trees 13 can then be searched on playback to find appropriated simulated responses 12 for commands 11 issued by the application module 130.

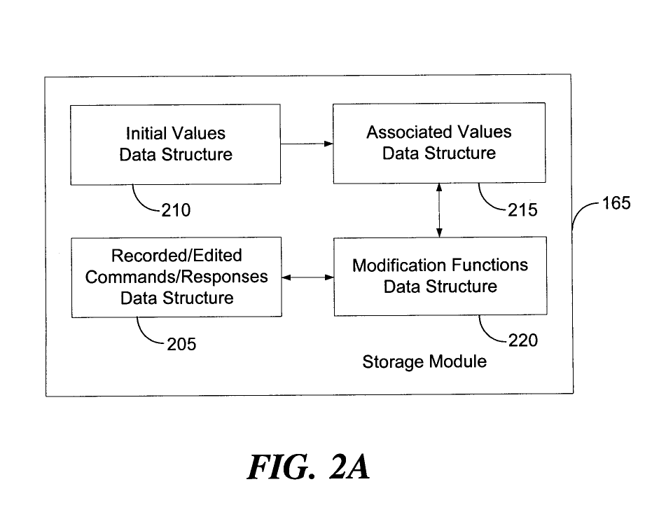

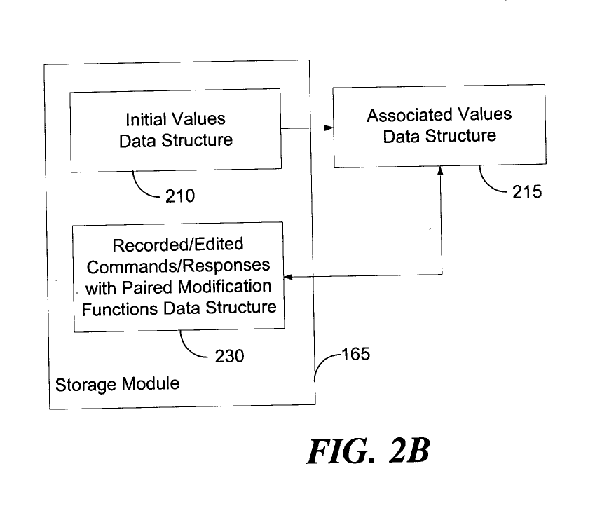

Using the editor module 165, regular expression Write matches and Visual Basic script Read responses can be added to the I/O to make the simulated I/O session better match the behavior of the instrument. A list of initial values for an associated array (i.e., initial values data structure 210 of FIGS. 2A and 2B) can be added by the editor module 165 so that the I/O simulation file can better simulate the initial state of the instrument. It has been found experimentally that often less than twenty regular expression write matches, each with one Visual Basic script read response, are needed to meet the simulation requirements of the IVI-COM (Interchangeable Virtual Instrument-Component Object Model) instrument driver standard. However, the more complex the instrument, the more regular expression write matches will be needed. Typically those regular expressions will be the same for other instruments that require IVI-COM drivers.

Also shown in FIG. 1 is a computer readable memory device 101 which can embody a computer program of instructions executable by the computer to perform the various functions described herein.

FIG. 2A is a drawing indicating various data structures of the storage module 165 of FIG. 1. As shown in FIG. 2A the storage module 165 comprises the following data structures: (1) a recorded/edited commands/responses data structure 205, (2) an initial values data structure 210, (3) an associated values data structure 215, and (4) a modification functions data structure 220.

The initial values data structure 210 is typically created manually using the editor module 165 and comprises values that describe the initial state of the instrument 145. As an example, the initial state of the instrument 145 could be described, among other items, by specifying that the instrument 145 is in voltage measurement mode, on the 0-10 volt scale, and has serial number 123-456. The data structure format of the initial values data structure 210 could be, for example, an array, a single or double linked list, a tree, an N-ary tree, or the like.

At some point (upon creation of the initial values data structure 210 and the associated values data structure 215, upon initiation of the simulation session, upon initiating a restore instruction, etc.), the editor module 165 or the simulation module 170 copies data in the initial values data structure 210 into the associated values data structure 215. The associated values data structure 215 could be created at runtime being filled at that time with the data from the initial values data structure 210 and could reside not in the storage module 160 as shown in FIG. 2A but in a separate memory structure as, for example, in Random Access Memory (RAM). Alternatively, the storage module 160 can be viewed to comprise both disk storage and RAM. As the simulation module 170 is stepped through various commands 11 with appropriate responses 12, the state of the simulated instrument changes. For instance, the simulated instrument could be instructed to change from measuring voltage on the 0-10 volt scale to measuring current on the 0-100 microamp scale. When this happens, the associated values data structure 215 is updated to reflect the new state of the simulated instrument. Thus, the simulated instrument is effectively a state machine whose current state is described by the values in the associated values data structure 215. The data structure format of the associated values data structure 215 could be, for example, an array, a single or double linked list, a tree, an N-ary tree, or the like.

During detection/record mode, commands 11 can be recorded, for example, into one or a number of tree data structures with each unique WRITE command 11 recorded into a parent node. If a WRITE or other command 11 is followed by a READ, it is assumed that the READ is associated with that WRITE or other command 11. This READ is then placed into a sub-node or child node of that WRITE or other command node. WRITES (e.g., measure a voltage) are parent nodes and the corresponding responses 12 (e.g., the voltage value measured) are their child nodes. The communications 10 detected and stored are recorded as an exact string structure. Logic to add the capabilities of matching using regular expressions and executing modification functions based on the regular expression match is found in the simulation module 170 and activated during the simulation mode.

During edit mode, the inflexibility of the recorded exact string structures of the commands 11 and responses 12 is replaced by the flexibility of providing potential matching via regular expressions by means of replacing similar communications 10 with appropriate generalized communications 10. Edit mode allows adding Visual Basic Script commands or other types of software functions for dynamic runtime behavior with these regular expression WRITE commands. For example, if a command 11 is sent to the instrument to set the range to 0 to 10.0 volts, a regular expression could match the command 11 for setting the voltage and allow any legal range, and the Visual Basic scripting (or other appropriate software functions) could be written to modify the associated values data structure 215 indicating that the virtual instrument's state includes a voltage range of 0 to 10 volts. Edit mode allows replacing the inflexibility of static responses with more dynamic behaviors. For example, a write command entry that causes the instrument to return a voltage could be associated with a Visual Basic Script response that could return a value within that range of 0 to 10 volts but with a semi-random distribution centered on a particular voltage (5 volts with a Gaussian distribution with a +/−0.5 volts 95% confidence interval, for example.). A WRITE which measures a current could be a separate parent node. The detect/record feature attempts to make the best fit possible by looking at how the data moves in over time. Without the use of the editor module 165 to create the initial values data structure 210, the associated values data structure 215, and the modification functions data structure 220, as well as the capability to do regular expression matching and execution of modification functions from the modification functions data structure 220 associated with the recorded/edited communications 10, simulation would be limited to only the set of communications 10 recorded during the detect/record mode. The modification functions in the modification functions data structure 220 could be, for example, Visual Basic scripts but are not limited to this technology. While for illustrative purposes the modification functions data structure 220 are shown separate from the recorded/edited commands/responses data structure 205, in a typical embodiment the appropriate entries of both data structures would be combined.

In a playback or simulation mode, a session is opened between the application module 130 and the simulation module 170. The application module 130 transfers a command 11 to the communication interface module 135 in the communication module 180 in a manner similar to that which it would do in sending the command 11 to the instrument 145. However, in the simulation mode, the command 11 instead is routed to the simulation module 170 via seventh communication path 27. Should, via eight communication path 28, a response 12 be found in the storage module 160 corresponding to the response to the command 11 just sent by the application module 130, that response 12 is retrieved from the storage module 160 and returned to the communication module 180 (via eight communication path 28) for appropriate formatting and validation in the manner described for the operational mode prior to transferring the message obtained from the storage module 160 to the application module 130.

Simulation of the application/instrument interactions is effected in the above manner by which it is possible for the application module 130 send and receive communications 10 as if it were communicating with the instrument 145 instead of the simulation module 170.

When a command 11 comes into the simulation module 170, the simulation module 170 searches the recorded/edited commands/responses data structure 205 looking for a match. If, for example, a command “MEAS:VOLT:RANGE 10” (set the instrument 145 voltage range to 10 volts) is issued by the application module 130, the simulation module 170 searches for this command 11 in the storage module 160. Once found, the simulation module 170 uses this command 11 for the subsequent read. If the string representing the communication 10 matches one of the regular expressions in the recorded/edited commands/responses data structure 205, the simulation module 170 will execute an associated modification function from the modification function data structure 220 which as previously stated could be a Visual Basic script. If a match is found, the simulation module would typically return to the application a return code indicating a completion of the command 11. Otherwise, a return code indicating a failure would typically be received. Property-state-setting commands 11 are especially aided by the ability to use regular expressions with Visual Basic Scripts in Write matches, since they can then parse the data being passed to the simulated instrument and simulate how that command would affect the instrument's state, as represented by the associated values data structure 215.

Most instruments 145 have a relatively broad range of commands 11, a number of which have a similar structure, but those commands 11 differ in the details of the strings in which those commands 11 are written. As an example, a voltage range could be set by the command MEAS:VOLTRANGE:50. A command 11 structure similar to that command 11 could be used to create a regular expression such that if an associated query is contained in the command 11 as evidenced by the presence of the “?” at the end of the command 11, the simulation module 170 knows to go to the associated values data structure 215 and retrieve a value previously obtained from the initial values data structure 210. In that manner the simulation module 170 does not have to have an entry for every single property that the instrument 145 might be capable of having.

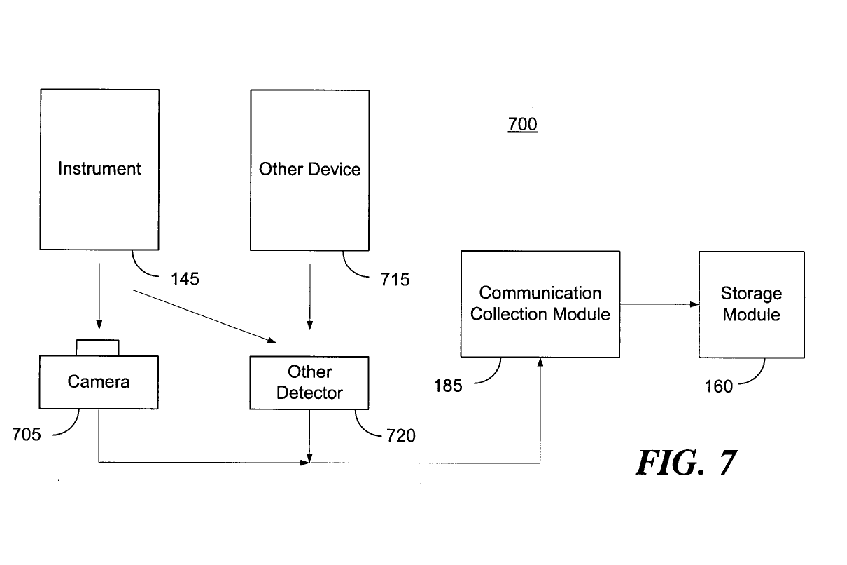

In another representative embodiment (see FIG. 7 and discussion of FIG. 7), a camera could be attached to the instrument 145 and actuated so as to take a photograph every time a command 11 is received. Then during playback there would be a virtual instrument on the screen of the computer showing the instrument as its front panel changed to reflect the condition of the simulated instrument. During detection/record mode, images of the actual instrument 145 are automatically captured by one or more cameras attached to the computer 133 and aimed at the front panel of the instrument 145 being recorded. The recorder module 155 captures an image at each I/O Read or Write event and stores that data inline with that event to be eventually saved in the storage module 160 with the associated communications 10. The virtual instrument front panel application would receive that image data from the simulation module 170 during simulation as each command 11 corresponding to an image occurred. The end result is a visual, virtual test system running with an application 130 that is written to communicate with the instrument 145, showing the visual effects of that application's operations on those instruments 145. Another camera or cameras could also be oriented on the device or devices being manipulated by that instrument 145 to show the effects of the application's operations on those device(s).

The application that talks to the instrument 145 would not need any modification or special operation during simulation other than to instruct it to use the simulated I/O addresses rather than the live operational I/O addresses. Aliasing of operational I/O addresses to simulated I/O addresses in the communication interface module 135 would remove that requirement.

In another embodiment, the simulation module 170 could be used to forward I/O calls from the simulated I/O device to a real I/O device, performing any necessary translation between how the application expects the simulated instrument to behave, and the behavior of the real instrument. This adapter layer allows programs that expect one model of instrument to work with a different instrument that has a different command syntax. For example, an instrument vendor could create a simulation file for a newer instrument that allows applications that were designed to use an older instrument with obsolete (for example, non-SCPI-compatible) syntax to use a newer instrument with modern syntax.

FIG. 2B is a drawing indicating alternative data structures of the storage module 165 of FIG. 1. As shown in FIG. 2B the storage module 165 comprises the following data structures: (1) a recorded/edited commands/responses with paired modification functions data structure 230 and (2) the initial values data structure 210. FIG. 2B differs from FIG. 2A in two respects. First, the modification functions are paired with their appropriate recorded/edited commands/responses in the recorded/edited commands/responses with paired modification functions data structure 230 rather than the two data structures of FIG. 2A. Second, the associated values data structure 215 is shown outside of the storage module 165 as would be the case if the associated values data structure 215 is created in RAM at start-up and the RAM is considered to be not a part of the storage module 165.

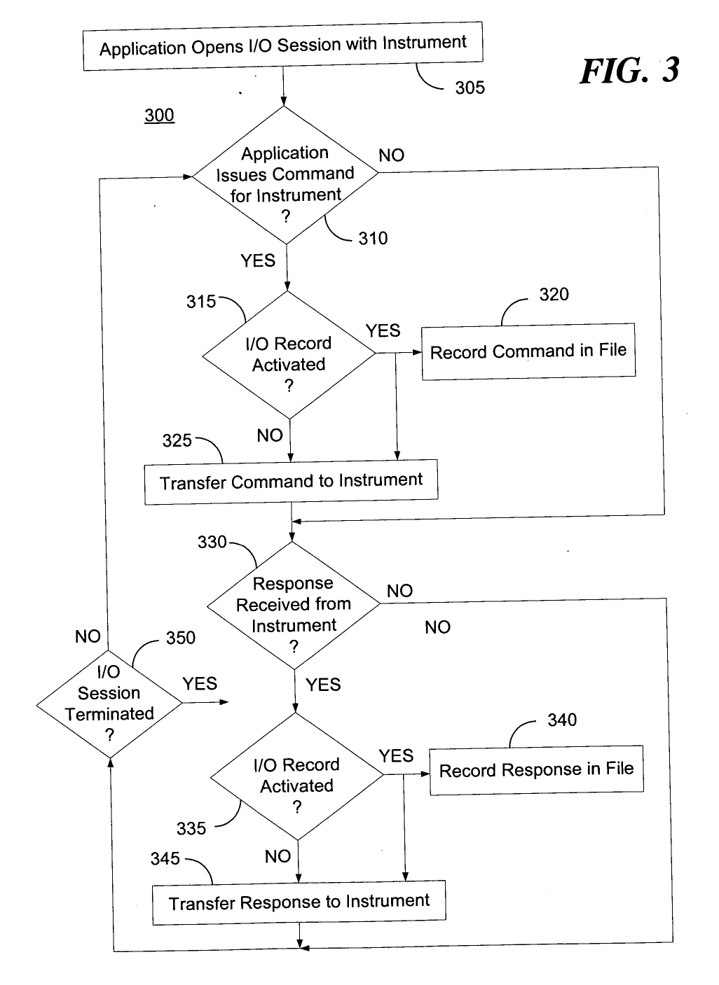

FIG. 3 is a flow chart of a method 300 for transferring communications 10 between the application module 130 and the instrument 145 and recording the communications 10. In block 305 of FIG. 3, the application module 130 opens an Input/Output session with the instrument 145. Block 305 then transfers control to block 310.

In block 310, if the application module 130 issues a command 11 for the instrument 145, block 310 transfers control to block 315. Otherwise, control is transferred to block 330.

In block 315, if Input/Output record mode is activated for the Input/Output session for the application module 130 and the instrument 145, block 315 transfers control to block 320 and to block 325. Otherwise, block 315 transfers control only to block 325.

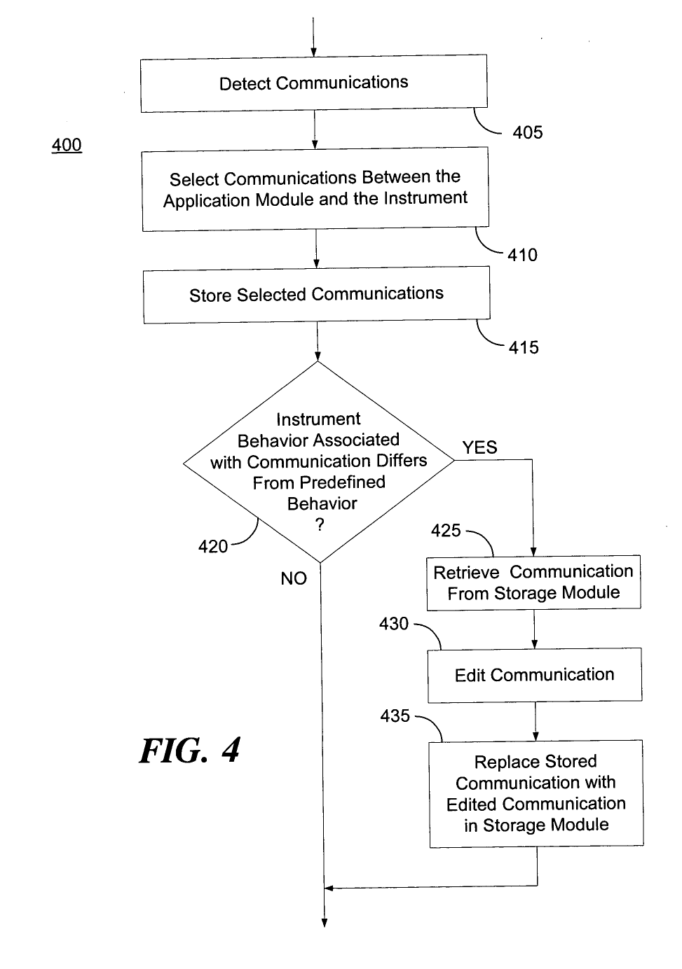

In block 320, the command 11 is stored or recorded in the storage module 160 by the communication collection module 185 for those commands 11 that are a part of the Input/Output session associated with the application module 130 and the instrument 145. An expanded description of block 320 comprises blocks 405, 410, and 415 of FIG. 4. Blocks 405, 410, and 415 will be described with the discussion of FIG. 4. Once, the actions of block 320 are completed, block 320 takes no further action.

In block 325, the command 11 is transferred to the instrument 145. Note that block 320 and block 325 do not depend upon each other and can be actuated in parallel. Once block 325 is complete, block 325 transfers control to block 330.

In block 330, if a response 12 is received from the instrument 145 which typically occurs in response to the command 11, block 330 transfers control to block 335. Otherwise, block 330 transfers control to block 350.

In block 335, if Input/Output record mode is activated for the Input/Output session for the application module 130 and the instrument 145, block 335 transfers control to block 340 and to block 345. Otherwise, block 335 transfers control only to block 345.

In block 340, the response 12 is stored or recorded in the storage module 160 by the communication collection module 185 for those responses 12 that are a part of the Input/Output session associated with the application module 130 and the instrument 145. An expanded description of block 340 comprises blocks 405, 410, and 415 of FIG. 4. Once again, blocks 405, 410, and 415 will be described with the discussion of FIG. 4. Once, the actions of block 340 are completed, block 340 takes no further action.

In block 345, the response 12 is transferred to the instrument 145. Note that block 340 and block 345 do not depend upon each other and can be actuated in parallel. Once block 345 is complete, block 345 transfers control to block 350.

In block 350, if the Input/Output session has been terminated, block 350 exits the process of FIG. 3. Otherwise, block 350 transfers control to block 310.

FIG. 4 is a flow chart of a method 400 for recording and editing communications 10 transferred between the application module 130 and the instrument 145. In block 405 of FIG. 4, the communication 10 flowing back and forth between the application module 130 and the instrument 145 are detected. Block 405 then transfers control to block 410.

In block 410, those communications 10 flowing back and forth on the communication link 20 belonging to the Input/Output session of the application module 130 and the instrument 145 are selected. Block 410 then transfers control to block 415.

In block 415, the selected communications 10 are stored in, for example the storage module 160. Block 415 then transfers control to block 420.

In block 420, if the instrument behavior associated with the communication 10 differs from a predefined behavior for that communication 10, block 420 transfers control to block 425. Otherwise, block 420 exits the process of FIG. 4.

In block 425, the stored communication 10 is retrieved from the storage module 160 by, for example, the editor module 165. Block 425 then transfers control to block 430.

In block 430, the retrieved communication 10 is edited. Block 430 then transfers control to block 435.

In block 435, the edited communication 10 replaces the communication 10 stored in, for example, the storage module 160. Block 435 then exits the process of FIG. 4.

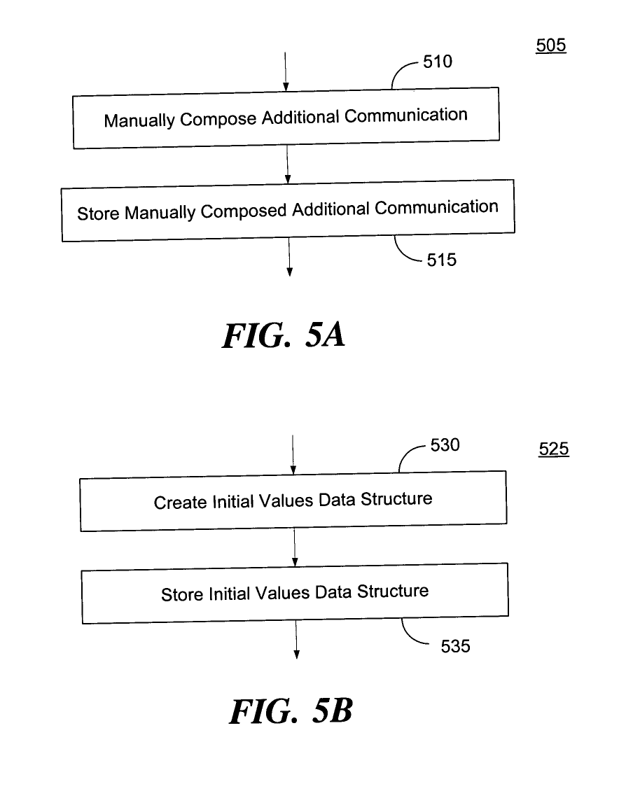

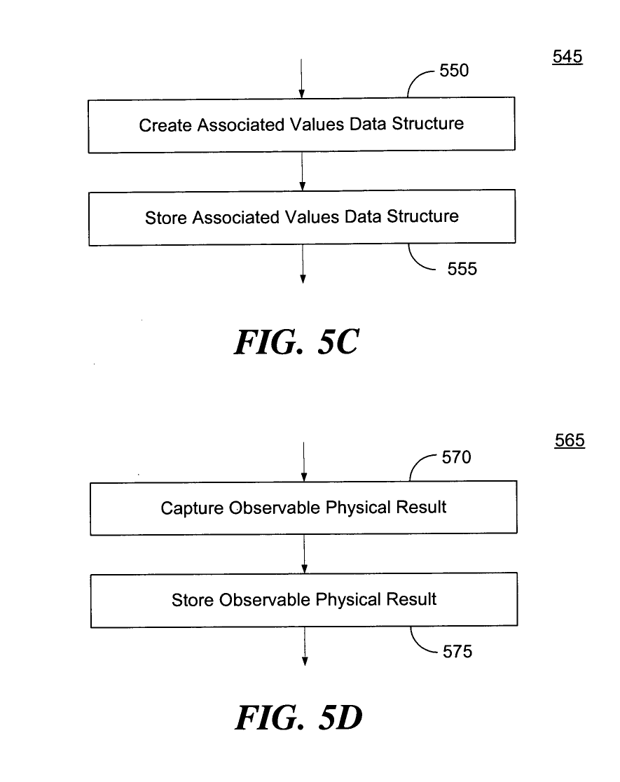

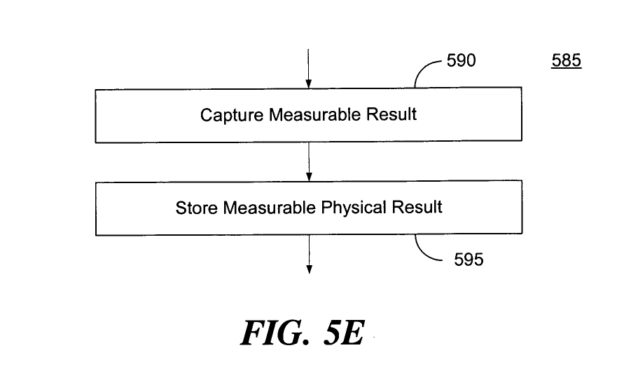

FIG. 5A is a flow chart of a method 505 for manually composing and storing communications 10. In block 510 of FIG. 5A, an additional communication 10 is composed manually by, for example, the editor 165. Block 510 then transfers control to block 515.

In block 515, the manually composed additional communication 510 is stored, for example, in the storage module 160. Block 515 then exits the process of FIG. 5A.

FIG. 5B is a flow chart of a method 525 for creating and storing the initial values data structure 210. In block 530 of FIG. 5B, the initial values data structure 210 is composed manually by, for example, the editor 165. Block 530 then transfers control to block 535.

In block 535, the manually composed initial values data structure 210 is stored, for example, in the storage module 160. Block 535 then exits the process of FIG. 5B.

FIG. 5C is a flow chart of a method 545 for creating and storing an associated values data structure. In block 550 of FIG. 5C, an associated values data structure 215 is composed manually by, for example, the editor 165. In an alternative embodiment, the initial values data structure 210 could be copied into the associated values data structure 215. Block 550 then transfers control to block 555.

In block 555, the manually composed associated values data structure 215 is stored, for example, in the storage module 160. Block 555 then exits the process of FIG. 5C.

FIG. 5D is a flow chart of a method 565 for capturing and storing observable physical results. In block 570 of FIG. 5D, observable physical results associated with a given communication 10 are captured by, for example, a camera attached to the instrument 145 and actuated so as to take a photograph every time a command 11 is received, to take a photograph of other device, or to capture some other observable result. As previously discussed, during playback there could be a virtual instrument on the screen of the computer 133 showing the instrument 145 as its front panel changed to reflect the condition of the simulated instrument. During detection/record mode, images of the actual instrument 145 are automatically captured by one or more cameras attached to the computer 133 and aimed at the front panel of the instrument 145 being recorded. Another camera or cameras could also be oriented on the device or devices being manipulated by that instrument 145 to show the effects of the application's operations on those device(s). Block 570 then transfers control to block 575.

In block 575, the captured observable physical results are stored. After capture, the recorder module 155 could, for example, store a representation of that observable physical results with that event to be eventually saved in the storage module 160 with the associated communication 10. The virtual instrument front panel application would receive that image data from the simulation module 170 during simulation as each command 11 corresponding to an image occurred. The end result could be a visual, virtual test system running with an application 130 that is written to communicate with the instrument 145, showing the visual effects of that application's operations on those instruments 145. Block 575 then exits the process of FIG. 5D.

FIG. 5E is a flow chart of a method 585 for capturing and storing measurable results. In block 590 of FIG. 5E, measurable results associated with a given communication 10 are captured. Block 590 then transfers control to block 595.

In block 595, the captured measurable results are stored in, for example, the storage module 160. Block 595 then exits the process of FIG. 5E.

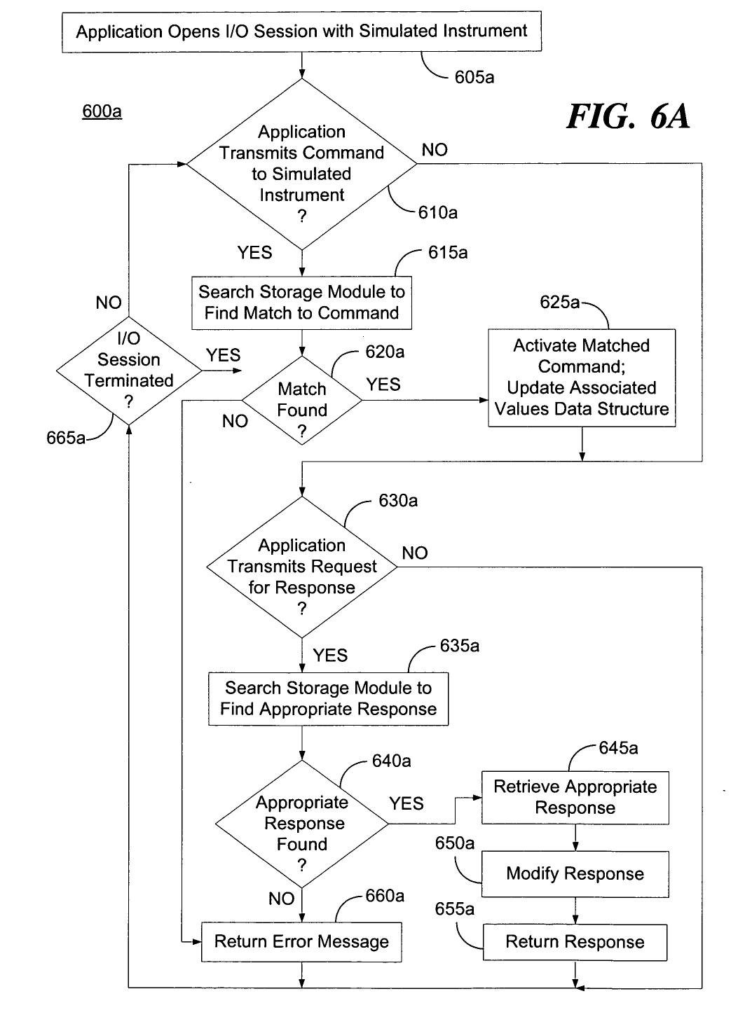

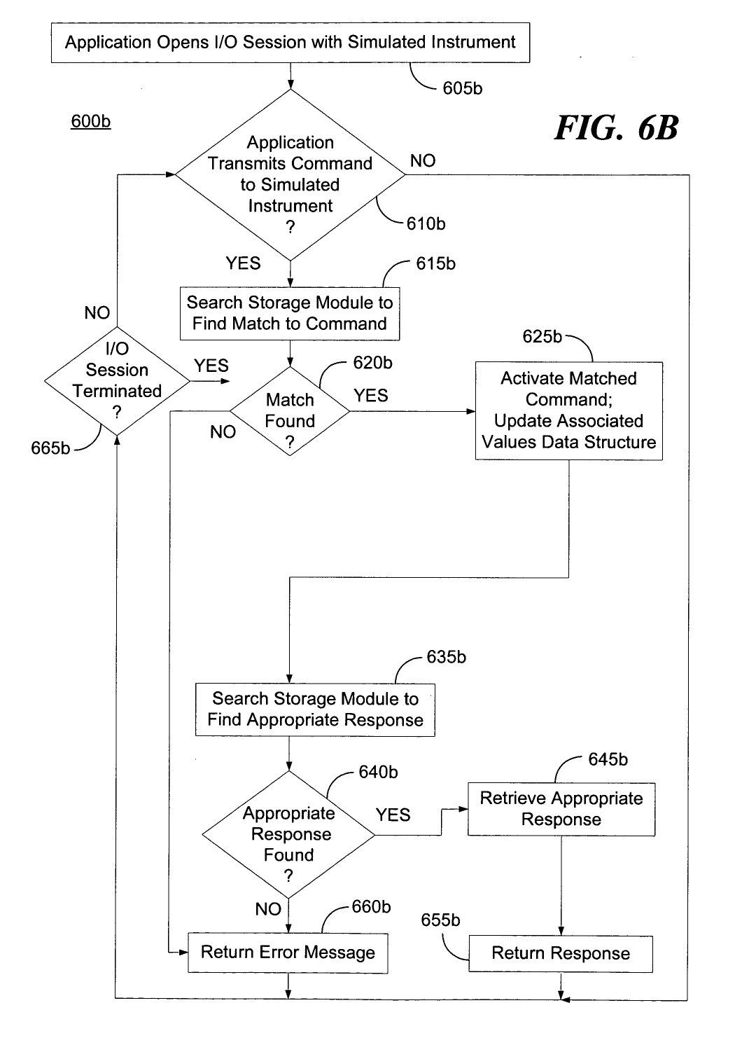

FIG. 6A is a flow chart of a method 600a for simulating communications 10 transferred between the application module 130 and the instrument 145. FIG. 6A is appropriate for Read and Write I/O commands 11 wherein the application module 130 may or may not request a response 12. In block 605a of FIG. 6A, a communication session is opened between the application 130 and the simulation module 170. Block 605a then transfers control to block 610a.

In block 610a, if a command 11 was transmitted by the application 130 to the simulation module 170, block 610a transfers control to block 615a. Otherwise, block 610a transfers control to block 630a In block 615a, the storage module 160 is searched for a best match to the command 11. Block 615a then transfers control to block 620a.

In block 620a, if an appropriate match to the command 11 was found, block 620a transfers control to block 625a. Otherwise, block 620a transfers control to block 660a.

In block 625a, the stored best match command 11 is activated which results in an updating of the associated values data structure 215 to reflect the new condition of the simulated instrument based upon the command 11 received. The functions specified in the associated modification functions data structure 220 paired with the stored best match command 11 are performed. The entry in the modification functions data structure 220 may in practice be a part of the command 11 as stored. Such modification may be performed by regular expression matching and actuating a Visual Basic Script. Block 625a then transfers control to block 630a.

In block 630a, if a request for a response 12 was received by the simulated instrument, block 630a transfers control to block 635a. Otherwise, block 630a transfers control to block 665a.

In block 635a, the storage module 160 is searched for an appropriate response 12 to return to the application 130. Block 635a, then transfers control to block 640a.

In block 640a, if an appropriate response 12 was found, block 640a transfers control to block 645a. Otherwise, block 640a transfers control to block 660a.

In block 645a, the appropriate response 12 is retrieved from the storage module 160. Block 645a then transfers control to block 650a.

In block 650a, the functions specified in the associated modification functions data structure 220 paired with the response 12 are performed. Again, the entry in the modification functions data structure 220 may in practice be a part of the response 12 as stored. Such modification may be performed by regular expression matching and actuating a Visual Basic Script. Block 650a then transfers control to block 655a.

In block 655a, the response 12 is returned from the simulation module 170 to the application module 130. Block 655a then transfers control to block 665a.

In block 660a, an error message is returned to the application module 130 to inform the application module 130 that an appropriate command 11 or matching response 12 could not be found. Block 660a then transfers control to block 665a.

In block-665a, if the simulated Input/Output session has been terminated, block 665a exits the process of FIG. 6A. Otherwise, block 665a transfers control back to block 610a.

FIG. 6B is a flow chart of another method 600b for simulating communications 10 transferred between the application module 130 and the instrument 145. FIG. 6B is appropriate for DoCommand commands 11 wherein the application module 130 does not request a response 12 but one is always returned. In block 605b of FIG. 6B, a communication session is opened between the application 130 and the simulation module 170. Block 605b then transfers control to block 610b.

In block 610b, if a command 11 was transmitted by the application 130 to the simulation module 170, block 610b transfers control to block 615b. Otherwise, block 610b transfers control to block 665b

In block 615b, the storage module 160 is searched for a best match to the command 11. Block 615b then transfers control to block 620b.

In block 620b, if an appropriate match to the command 11 was found, block 620b transfers control to block 625b. Otherwise, block 620b transfers control to block 660b.

In block 625b, the stored best match command 11 is activated which results in an updating of the associated values data structure 215 to reflect the new condition of the simulated instrument based upon the command 11 received. Block 625b then transfers control to block 635b.

In block 635b, the storage module 160 is searched for an appropriate response 12 to return to the application 130. Block 635b, then transfers control to block 640b.

In block 640b, if an appropriate response 12 was found, block 640b transfers control to block 645b. Otherwise, block 640b transfers control to block 660b.

In block 645b, the appropriate response 12 is retrieved from the storage module 160. Block 645b then transfers control to block 655b.

In block 655b, the response 12 is returned from the simulation module 170 to the application module 130. Block 655b then transfers control to block 665b.

In block 660b, an error message is returned to the application module 130 to inform the application module 130 that an appropriate command 11 or matching response 12 could not be found. Block 660b then transfers control to block 665b.

In block 665b, if the simulated Input/Output session has been terminated, block 665b exits the process of FIG. 6B. Otherwise, block 665b transfers control back to block 610b.

FIG. 7 is a drawing of an apparatus for capturing and storing observable physical results. In FIG. 7, a camera 705 is aimed at and possibly attached to the instrument 145. The camera 705 is actuated so as to take a photograph every time a command 11 is received. Then during playback there would be a virtual instrument on the screen of the computer 133 showing the instrument 145 as its front panel changed to reflect the condition of the simulated instrument. During detection/record mode, images of the actual instrument 145 are automatically captured by one or more cameras 705 attached to the computer 133 and aimed at the front panel of the instrument 145 being recorded. The communication collection module 185 collects the images and matches them with the command 11 that changed the state of the instrument 145. In particular, the communication collection module 185 captures an image at each I/O Read or Write event and stores that data inline with that event to be eventually saved in the storage module 160 with the associated communications 10. The virtual instrument front panel application would receive that image data from the simulation module 170 during simulation as each command 11 corresponding to an image occurred. Again, the end result is a visual, virtual test system running with an application 130 that is written to communicate with the instrument 145, showing the visual effects of that application's operations on those instruments 145. Another camera 705 or cameras 705 or other detector 720 could also be oriented on a device 715 or devices 715 being manipulated by that instrument 145 to show the effects of the application's operations on those device(s) 715.

As is the case, in many data-processing products, the systems described above may be implemented as a combination of hardware and software components. Moreover, the functionality required for use of the representative embodiments may be embodied in computer-readable media (such as floppy disks, conventional hard disks, DVD's, CD-ROM's, Flash ROM's, nonvolatile ROM, and RAM) to be used in programming an information-processing apparatus (e.g., the computer 133 comprising the elements shown in FIG. 1 among others) to perform in accordance with the techniques so described.

The term “program storage medium” is broadly defined herein to include any kind of computer memory such as, but not limited to, floppy disks, conventional hard disks, DVD's, CD-ROM's, Flash ROM's, nonvolatile ROM, and RAM.

The camera can be any imaging system. However, a digital camera whether still or motion would be preferable. The operation of the editor module 165 and activation/operation of the simulation module 170 can be performed using a graphical user interface (GUI) interfaced program. The computer 133 can be capable of running any commercially available operating system such as a version of Microsoft Windows or other suitable operating system.

Novel techniques have been disclosed herein for simulating the operation of an instrument under the control of an application by recording communications between an application and an instrument, by the editing of those recorded communications, and by the subsequent playback of the recorded/edited communications. Using these techniques, a user can simulate interactions between an application and an instrument such that it would appear to the application as if the instrument were actually present when in fact stimulus communications from the application are used to select and return to the application appropriate, prerecorded instrument response messages.

By recording communications (i.e., I/O communications) between an application and an instrument and by editing the recorded communications as appropriate, it has been shown above that it is possible to customize test cases of software code that communicate with an instrument, reliably repeat tests of I/O related software code, and more easily observe the behavior of the code under test without causing instrumentation side-effects. The recorded I/O can be edited to test corner cases and to achieve better test coverage. Because the stored code can be deterministic if desired, the tests will have the same behavior from test-run to test-run, unlike most tests using real instruments. Because the playback system can be paused indefinitely during debugging without changing its behavior, test code can be more easily observed and monitored than in “live” instrument environments where the behavior of the external devices is often predicated on time.

Being able to virtually expand the number of available instruments by pre-recording instrument behavior can significantly increase the possible parallel development work, increase organizational efficiency, and decrease the product cycle time without purchase of more instruments than are normally required.

Instrument simulation permits more flexible use of software controlled instruments. It is sometimes difficult to transport instruments, or especially instrument systems. By providing a method of using such software without the instruments themselves, it is easier to, for example, demonstrate such software in foreign countries, use the software on instruments that are still under development, and create scenarios and behaviors not possible with real instruments.

Using implementations of the representative embodiments disclosed herein, an instrument developer can record exactly what an instrument did, including its delays before returning from each command. The user can use editing features to modify that data in any way appropriate. Static data can be replaced with functions which could be, for example, written as Visual Basic scripts, which specify various instrument behaviors, and which keep track of the simulated instrument's state via an array or other mechanism associated with the instrument and the initiating application.

Thus, in addition to others the techniques disclosed herein provide for enhanced testing of I/O-related software code, “virtual” sharing of limited instrument resources, and more flexible use of I/O-related software code.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method for recording and modifying communications, comprising:
detecting communications occurring on a communication link;
selecting those communications from the detected communications that occur between an application module and an instrument, wherein the instrument behavior associated with at least one of the selected communications differs from a predefined instrument behavior for that selected communication;
storing the selected communications in a storage module;
for the at least one of the selected communications whose associated instrument behavior differs from the predefined instrument behavior, retrieving that communication from the storage module;
editing the retrieved communication such that the resultant instrument behavior associated with the edited communication emulates the predefined instrument behavior; and
in the storage module, replacing the retrieved communication with the edited communication.

2. The method as recited in claim 1, wherein the stored communications are stored in a storage module selected from the group consisting of a file, a database, an array, a list, a linked list, a tree, and an N-ary tree.

3. The method as recited in claim 1, further comprising:
manually composing at least one additional communication, wherein the manually composed at least one additional communication emulates communication on the communication link between the application module and the instrument; and
storing the manually composed at least one additional communication.

4. The method as recited in claim 1, further comprising:
creating an initial values data structure associated with the instrument, wherein initial values stored in the initial values data structure describe an initial state of the instrument.

5. The method as recited in claim 1, further comprising:
creating an associated values data structure associated with the instrument, wherein values stored in the associated values data structure are modified during simulation so as to describe the current state of the instrument.

6. The method as recited in claim 1, wherein a variable element in at least one of the selected communications is associated with an item selected from the group consisting of a variable, a literal, and a procedure.

7. The method as recited in claim 1, wherein at least one of the selected communications comprises a regular expression and wherein the editing step comprises editing the regular expression in the at least one of the selected communications.

8. The method as recited in claim 1, further comprising:
capturing at least one observable physical result of at least one of the selected communications; and
storing the at least one observable physical result of that at least one of the selected communications.

9. The method as recited in claim 8, wherein the at least one observable physical result of the at least one of the selected communications is obtained from a device other than the instrument.

10. The method as recited in claim 8, wherein the observable physical result is a physical condition of the instrument panel resultant from the at least one of the selected communications.

11. The method as recited in claim 10, wherein an image of the physical condition of the instrument panel resultant from the at least one of the selected communications is obtained by a camera aimed at the instrument front panel.

12. The method as recited in claim 1, further comprising:
capturing at least one measurable result of at least one of the selected communications; and
storing the at least one measurable result of that at least one of the selected communications.

13. The method as recited in claim 12, wherein the at least one measurable result of the at least one of the selected communications is obtain from a device other than the instrument.

14. The method as recited in claim 1, wherein the selected communications are stored in a data format selected from the group consisting of a text markup language file format, an extensible markup language (XML) format, a structured storage file format, a custom relational file format, and a custom framed binary format.

15. A computer readable memory device embodying a computer program of instructions executable by the computer, the instructions comprising:
detecting communications occurring on a communication link;
selecting those communications from the detected communications that occur between an application module and an instrument, wherein the instrument behavior associated with at least one of the selected communications differs from a predefined instrument behavior for that selected communication;
storing the selected communications in a storage module;
for the at least one of the selected communications whose associated instrument behavior differs from the predefined instrument behavior, retrieving that communication from the storage module;
editing the retrieved communication such that the resultant instrument behavior associated with the edited communication emulates the predefined instrument behavior; and
in the storage module, replacing the retrieved communication with the edited communication.

16. The computer readable memory device as recited in claim 15, wherein the stored communications are stored in a storage module selected from the group consisting of a file, a database, an array, a list, a linked list, a tree, and an N-ary tree.

17. The computer readable memory device as recited in claim 15, further comprising:
manually composing at least one additional communication, wherein the manually composed at least one additional communication emulates communication on the communication link between the application module and the instrument; and
storing the manually composed at least one additional communication.

18. The computer readable memory device as recited in claim 15, further comprising:
creating an initial values data structure associated with the instrument, wherein values stored in the initial values data structure describe an initial state of the instrument.

19. The computer readable memory device as recited in claim 15, further comprising:
creating an associated values data structure associated with the instrument, wherein values stored in the associated values data structure are modified during simulation so as to describe the current state of the instrument.

20. The computer readable memory device as recited in claim 15, wherein a variable element in at least one of the selected communications [10] is associated with an item selected from the group consisting of a variable, a literal, and a procedure.

21. The computer readable memory device as recited in claim 15, wherein at least one of the selected communications comprises a regular expression and wherein the editing step comprises editing the regular expression in the at least one of the selected communications.

22. The computer readable memory device as recited in claim 15, further comprising:
capturing at least one observable physical result of at least one of the selected communications; and
storing the at least one observable physical result of that at least one of the selected communications.

23. The computer readable memory device as recited in claim 22, wherein the at least one observable physical result of the at least one of the selected communications is obtained from a device other than the instrument.

24. The computer readable memory device as recited in claim 22, wherein the observable physical result is a physical condition of the instrument panel resultant from the at least one of the selected communications.

25. The computer readable memory device as recited in claim 24, wherein an image of the physical condition of the instrument panel resultant from the at least one of the selected communications is obtained by a camera aimed at the instrument front panel.

26. The computer readable memory device as recited in claim 15, further comprising:
capturing at least one measurable result of at least one of the selected communications; and
storing the at least one measurable result of that at least one of the selected communications.

27. The computer readable memory device as recited in claim 26, wherein the at least one measurable result of the at least one of the selected communications is obtain from a device other than the instrument.

28. The computer readable memory device as recited in claim 15, wherein the selected communications are stored in a data format selected from the group consisting of a text markup language file format, an extensible markup language (XML) format, a structured storage file format, a custom relational file format, and a custom framed binary format.
